(19) United States
(12) Patent Application Publication
(10) Pub. No.: US 2006/0184658 A1
(43) Pub. Date: Aug. 17, 2006

(54) SYSTEM AND METHOD FOR TRACING A DATA PATH ACROSS OFF-NETWORK DISTRIBUTIONS

(75) Inventor: Raymond Riddell, Cambridge (CA)

Correspondence Address: Mark James Young, 12086 Fort Caroline Rd., Unit 202, Jacksonville, FL, 32225, US

(73) Assignee: 993504 ONTARIO LIMITED, Cambridge (CA)

(21) Appl. No.: 10/908,550

(22) Filed: May 16, 2005

Related U.S. Application Data
(60) Provisional application No. 60/646,396, filed on Jan. 24, 2005.

(51) Int. Cl. G06F 15/173

(52) U.S. Cl. 709/224

(57) ABSTRACT

A system and method for tracking data stores identification data on a portable storage device physically present at the point of delivery. The identification data, which is associated with an identification of the first recipient, is provided to the first recipient for delivery to an end-user on a portable storage device. Upon use of the portable storage device, the identification data is communicated via network to a tracking computing device. An identity marker may be stored on an end-user computing device for subsequent tracking. The first recipient may receive compensation in consideration of the transaction, in the form of monetary or non-monetary compensation, or anything of significance.

### RELATED APPLICATION

This application claims the benefit of priority to U.S. Provisional Application No. 60/646,396 filed Jan. 24, 2005, the entire contents of which are incorporated herein and made a part hereof.

### FIELD OF THE INVENTION

This invention generally relates to a system and method for tracing and determining the origin, creator and data path of data, and more particularly, to a system and method for tracking and determining the origin, creator and data path of a specific data storage medium containing unique and specific identifying data when the storage medium is used on a data storage device connected to a network communicatively coupled to a remote computing device.

### BACKGROUND

With the advent of the Internet and an ever-growing need to expand markets, brick and mortar companies along with Internet companies continually search for new ways to integrate their mediums. For example, the Internet allows consumers to purchase goods and services online using electronic payment gateways.

To better leverage the Internet to garner more sales and exposure, businesses frequently conduct mass email campaigns, online electronic banner advertising, advertising through adware programs and many other online activities. In addition, some merchants use traditional advertising media such as radio, television and print advertising to drive visitors to their websites.

Each of the methods previously mentioned along with countless others share a common problem. When a consumer arrives at a website using one of these methods, the site owner does not know the advertising campaign that drove the visitor to the website. Even if the website includes a form that requests the origin from the visitor, many visitors will ignore the request, accept a default entry or enter the first acceptable choice.

Concomitantly, businesses that employ brick and mortar strategies to advertise their products or services have no way to directly account for business generated by off-line or out-of-network methods. Rather, they must use traditional accounting methods that rely on general statistics and data in the form of server logs, instead of actual origin data to determine the effectiveness of advertising and promotional activities.

Furthermore, if a visitor to a website learned of the website from an off-line or out-of-network source, then the website owner has no way to directly compensate a referring business for the visitor referred to the website and any ensuing business. The website cannot identify the visitor to the website as having been directed by a specific brick and mortar or off-line business partner.

Therefore, there is a need for a system and method that can track and determine the origin, creator and data path of a specific data storage medium containing unique and specific identifying data when the storage medium is used on a data storage device connected to a network communicatively coupled to a remote computing device. The invention is directed to overcoming one or more of the problems as set forth above.

### SUMMARY OF THE INVENTION

To solve one or more of the problems set forth above, in an exemplary implementation of the invention, a system and method for tracking data is provided. An exemplary method for tracking data according to principles of the invention entails associating identification data with a first recipient. A database record that includes an identification of the first recipient may be created and used for tracking. Then the identification data is communicated to the first recipient for provision to an end-user on a portable out-of-network storage device. The end-user may physically transport the portable out-of-network storage device and use it in conjunction with an end-user computing device having network connectivity. Then the identification data is received by a tracking computing device via network communication upon use of the portable out-of-network storage device by the end-user in conjunction with the end-user computing device having network connectivity. Use of the portable out-of-network storage device by said end-user may therefore be associated with said first recipient. The portable out-of-network storage device may be any portable storage medium, portable non-volatile memory, or portable computing device, whether now known or hereafter developed. The portable out-of-network storage device, with said identification data stored thereon, may be delivered to the first recipient. Alternatively, the identification data may be delivered to a portable out-of-network storage device possessed by an end-user. When communication connectivity is established between the end user computing device and a tracking computing device, the identification data is transmitted from the end user computing device to the tracking computing device. An identity marker may then be transmitted from the tracking computing device to the end user computing device. The first recipient may then be compensated for use of the portable out-of-network storage device by the end-user. Such compensation may include monetary compensation, non-monetary compensation, a credit, a discount, a rebate, a priority, an award and/or any other item of value, or any combinations of any the foregoing.

An exemplary system for tracking data according to principles of the invention, includes an originating computing device configured to associate identification data with a first recipient and to communicate identification data to a first recipient. The exemplary system also includes a tracking computing device configured to receive the identification data via network communication upon use by an end-user of a portable out-of-network storage device with the identification data stored thereon in conjunction with an end user computing device and to associate use of the portable out-of-network storage device by said end-user computing device with the first recipient. The originating computer system and the tracking computer system may be part of an integrated computer system or part of a distributed computer system. The originating computer system may further be configured to determine the first recipient. The portable out-of-network storage device may be a portable storage medium, a portable non-volatile memory, and/or a portable computing device. The originating computing device may further be configured to create a database record that includes the identification data and an identification of the first recipient. The tracking computing device may be configured to receive the identification data from the end user computing device and to transmit an identity marker to the end user computing device.

The invention thus enables tracing an origin, creator and data path of data, and more particularly, tracking and determining an origin, creator and data path of a specific data storage medium containing unique and specific identifying data when the storage medium is used on a data storage device communicatively coupled to a tracking computing device. A storage medium may be tracked from an originator to a first recipient and to an end-user. This tracking is enabled by providing the identification data on the storage medium to a tracking computing device when the storage medium is utilized by an end-user. Use of the portable storage device by an end user(s) may be correlated with the first recipient's identity which is associated with the identification data on the storage device. Thus, the first recipient (e.g., a retailer) may be duly credited for the end-user's utilization and any ensuing transaction(s).

As used herein the adjective “first” in the term “first recipient” is intended to denote a recipient, without limiting the recipient to any particular order in a chain of recipients, and without requiring more than one or any particular number of recipients. “Out-of-network” means with a network connection that can enable communication with an originating or tracking computing device.

### BRIEF DESCRIPTION OF THE DRAWINGS

The foregoing and other objects, aspects and advantages will be better understood from the following detailed description of an embodiment of the invention with reference to the drawings, in which:

FIG. 1 conceptually illustrates a high level block diagram and flow chart of a system and steps of a methodology according to an exemplary implementation of the invention;

FIG. 2 conceptually illustrates a process of using an originator, such as an originating computer system, to produce a data storage medium marked with identification data according to an exemplary implementation of the invention;

FIG. 3 conceptually illustrates a relationship of a data storage medium marked with identification data to an off-line data storage device, such as a hard drive of an end-user's computer according to an exemplary implementation of the invention;

FIG. 4 conceptually illustrates a relationship of an off-line data storage device containing an identification data to an on-line or network data storage device, such as a tracking computing device, according to an exemplary implementation of the invention;

FIG. 5 conceptually illustrates a step of identification of an off-line data storage device and data storage medium by an on-line or network data storage device according to an exemplary implementation of the invention;

FIG. 6 conceptually illustrates an online or network data storage device placing an identity marker on an off-line data storage device, where the data may reside for future identification according to an exemplary implementation of the invention;

FIG. 7 conceptually illustrates an online or network data storage device interacting with an off-line data storage device that has an identity marker according to an exemplary implementation of the invention; and

FIG. 8 conceptually illustrates a plurality of offline data storage devices each of which has an identity marker, and an originator of a data storage medium being identified by the on line network data storage device as being associated with being the originator of the data storage medium with an online or network data storage device according to an exemplary implementation of the invention;

FIG. 9 conceptually illustrates a high level block diagram and flow chart of a system and steps of a methodology according to an exemplary implementation of the invention; and

FIG. 10 conceptually illustrates a data flow diagram for an exemplary system and methodology according to an exemplary implementation of the invention.

### DETAILED DESCRIPTION

The present invention is directed to a system and methodology for tracing an origin, creator and data path of data, and more particularly, to a system and method for tracking and determining an origin, creator and data path of a specific data storage medium containing unique and specific identifying data when the storage medium is used on a device connected to a network communicatively coupled to a remote computer.

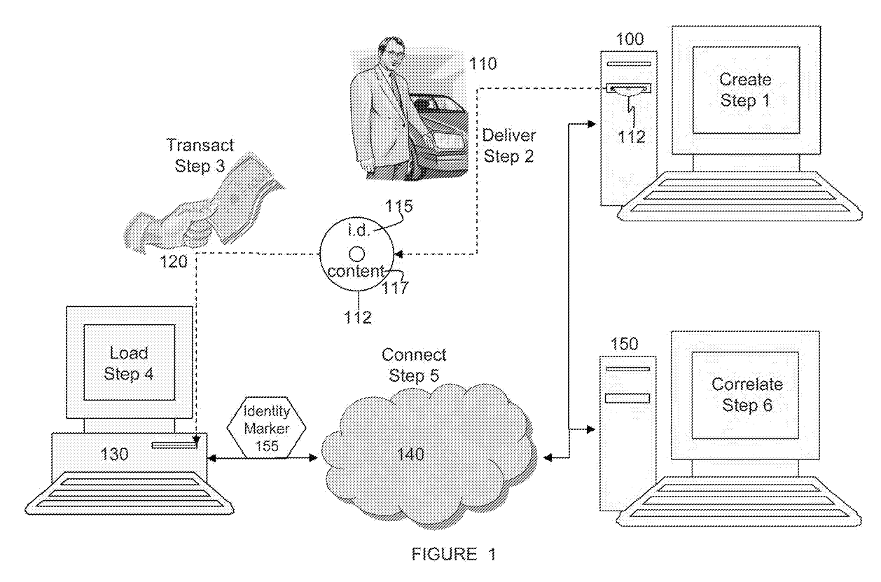

Referring now to FIG. 1, a high level block diagram and flow chart illustrates components of a system and steps of a methodology according to an exemplary implementation of the invention. An originating computing device 100 contains software for storing identification data 115 on a data storage device 112, as discussed more fully below. The originating computing device 100 also includes a device for writing to and reading from removable media, such as, for example, a CD-R/RW and/or DVD-R/RW drive. Of course, the originating computing device 100 may include additional elements. Additionally, the originating computing device 100 may either stand alone or operate in a distributed environment. The originating computing device 100 is intended to represent a broad range of data storage and computing devices capable of performing functions according to Step 1, as discussed below.

The removable storage medium 112, may be any means of non-volatile removable storage, such as, for example, a floppy disk, diskette, a CD-ROM, a DVD, flash RAM, a card with a magnetic stripe, a smart card or any other non-volatile removable storage means now known or later developed.

In Step 1 of an exemplary process according to the invention, the originating computing device 100 adds computer code to a storage medium 112. A vendor, distributor, marketing firm, replication service provider or some other party in a supply chain may carry out Step 1. The computer code includes identification data 115. By way of example and not limitation, the code may include a data and key pair comprised of a unique identifying code and additional code to represent products or services to be promoted. Both sets of code in combination form a unique identifier. The code combination may be used to positively identify a data storage device and an origin of the associated data storage medium. The identification data 115 may be stored in a database or table on the originating computing device 100. Subsequently, the identification data 115 may be associated with one or more lower-tier participants in the supply chain, such as recipients and users.

Other content 117 such as information, audio, graphics, video, multimedia, games, scripts, programs and other computer software may be stored on the storage medium 112. Additionally, the content 117 may include software to facilitate network communication with a tracking computing device 150, including transmission of the identification data 115.

Next, as in Step 2, the storage medium 112 is delivered to a first recipient 110 off-line. By way of illustration and not limitation, the first recipient 110 may be a retailer, kiosk, sales agent, sales representative or some other person, entity, device or location in a supply chain. An objective of this step is to position the storage medium 112 for eventual delivery to an end-user, such as a consumer. Thus, for example, the storage medium 112 may be provided to retailers for delivery to consumers. The storage medium 112 may accompany products for sale to consumers, include content for sale to end-users, or be distributed to end users in any other manner. At the time the originator provides the data storage medium 112 to the first recipient 110, an identification of the first recipient 110 may be stored and associated with the identification data 115 for the storage medium 112 in a database or table on the originating computing device 100.

Those skilled in the art will appreciate that the participants (e.g., the originator and recipient) may represent individual people, entities, or businesses. Additionally, other participants may be involved in phases of a methodology according to principles of the invention, such as processing companies, clearinghouses, loyalty companies, incentive companies, service providers and/or the like.

Next, as in Step 3, an end-user receives a copy of the storage medium 112. The storage medium 112 may be sold, freely given, or otherwise provided to an end-user, alone or accompanying another product or service pursuant to a transaction. Upon completing Step 3, the end-user possesses the storage medium 112, which has been marked with the identification data 115, and is configured to facilitate communication of the identification data 115 to a tracking computing device 150. Because the identification data 115 is associated with one or more lower-tier participants in the supply chain, such as a retail recipient, use of the storage medium can be attributed to such participant(s).

Advantageously, this embodiment of the invention provides brick and mortar establishments establishment opportunity to efficiently benefit from subsequent on-line activity by its patrons. To achieve the foregoing, the patron may be physically present at the brick and mortar establishment (i.e., the location for receiving the storage medium). Alternatively, the storage medium may be physically delivered to a destination (i.e., point of delivery) where the end-user is present. In each case, this embodiment contemplates physical presence at the point of delivery for an end-user to receive the identification data.

In Step 4, an end-user who has received a copy of the storage medium 112 loads the storage medium 112 onto a compatible data storage device with network (e.g., Internet) connectivity, such as an end-user data storage device 130. In an exemplary embodiment, the storage medium 112 is configured to facilitate communication with a tracking computing device 150. When an end-user loads the storage medium 112 in an end-user data storage device 130, as in Step 4, the storage medium 112 may initiate an online network communication session between the end-user data storage device 130 and a tracking computing device 150, as in Step 5. The loaded storage medium may initiate the online session by establishing an Internet connection, launching a browser and invoking a website or other Internet service configured to receive the identification data 115 and communicate the data to a tracking computing device 150. As another option, a program on the storage medium may initiate modem-to-modem communications between the end-user data storage device 130 and the tracking computing device 150. Alternatively, a program on the storage medium 112 may connect to the Internet and to a web server configured to receive the identification data 115 and communicate the data to a tracking computing device 150. The tracking computing device 150 may be a web server with a software agent/component configured to read the identification data 115, along with other potential information (e.g., end-user identification, etc.). Any other techniques for establishing a network connection directly or indirectly between the end-user data storage device 130 and the tracking computing device 150 and providing the identification data 115 may be utilized without departing from the scope of the invention.

In use, the storage medium may be tracked from an originator 100 to a first recipient 110 and to an end-user 130. This tracking is enabled by providing the identification data 115 on the storage medium to a tracking computing device 150 when the storage medium is utilized by an end-user. Use of the storage medium 112 by an end user 130 may be correlated with the first recipient 110's identity which is associated with the identification data on the storage medium. Thus, the first recipient 110 (e.g., a retailer) may be duly credited for the end-user's utilization and any ensuing transaction. As will become apparent hereinafter, various features may be afforded by associating an off-network recipient with a storage medium utilized by an end-user.

In a further embodiment, the storage medium may include exterior detectible indicia, such as a visible barcode or alphanumeric rendition of the identification data 115. The identity of each intermediate recipient (e.g., a retailer who receives the storage medium from a distributor, who received the storage medium from the originator) along with the identification data may be communicated to a tracking computing device 150. This enables maintenance of a chain of possession of the storage medium 112. Thus, a database created by the originating computer 100 may associate each recipient (i.e., a first recipient 110 and each intermediate recipient) with the identification data 115. The data may be provided by each intermediate recipient or sender using conventional on-line communication methods. Illustratively, access to a website or software may be provided to each recipient of a supply chain to provide the data to the originating computing device 100 and/or the tracking computing device 150. The data may be manually entered or automatically entered from an inventory management program.

The tracking computing device 150 is configured to perform several functions, such as maintaining communication sessions with one or more end-user data storage devices, and possibly one or more intermediate recipients. The tracking computing device 150 may also maintain or have access to a database (or table) of identification data, intermediate recipient data, and other information available concerning the storage medium 112. The tracking computing device 150 and the originating computer 100 may be separate, communicatively coupled, or one and the same. Of course, the computer 150 may include additional elements. Additionally, the computer system 150 may either stand alone or operate in a distributed environment. The tracking computing device 150 is intended to represent a broad range of computing devices capable of performing functions according to the invention.

In an exemplary implementation, the tracking computing device 150 is also configured to communicate an identity marker 155 for storage on the end-user data storage device 130. The identity marker 155 may be used to identify the end-user in future sessions between the tracking computing device and the end-user data storage device 130, without the need for the data storage medium 112. The identity marker 155 may be correlated with the originator 100 and the identity of the first recipient 110 in such future sessions.

Thus an exemplary method according to the invention enables identification and authentication of user(s) of the system as it relates to an origin and stemming from a specific off-line or out of network source (i.e., a recipient). This enables an online database to record these electronic transactions and refer to them for other transactions. Long-term and short-term tracking may be accomplished by the placement of digital markers on a user's machine that identifies the user now and in the future for crediting the off-line source (i.e., recipient) for the visit. The credit may include possible financial compensation or some other perquisite. The data storage medium 112 introduced to the off-line, out of network, data storage device enables the foregoing, as discussed above. This data storage medium 112 contains the identification data 115 that will bind (i.e., associate) the transactions and parties. The associated data provides a basis for countless transactions unlimited in scope and kind.

Those skilled in the art will appreciate that a system and method according to the invention offers many advantages. For example, a system according to the invention has no limits to the extensibility and usefulness of the purpose that it may serve. It is not limited to any one kind of on-line off-line relationship, and has infinite permutations and applications. Additionally, the invention simplifies and facilitates relationship management between off-line and on-line transaction participants. It enables tracking transactions that would otherwise not be practicable. The system also allows for extensible flexibility, enabling any number of data storage devices combined with an infinite number of on- and off-line and out-of-network data storage devices to be involved in the creation of relationships as outlined above. Furthermore, transactions can be implemented over secure and insecure environments.

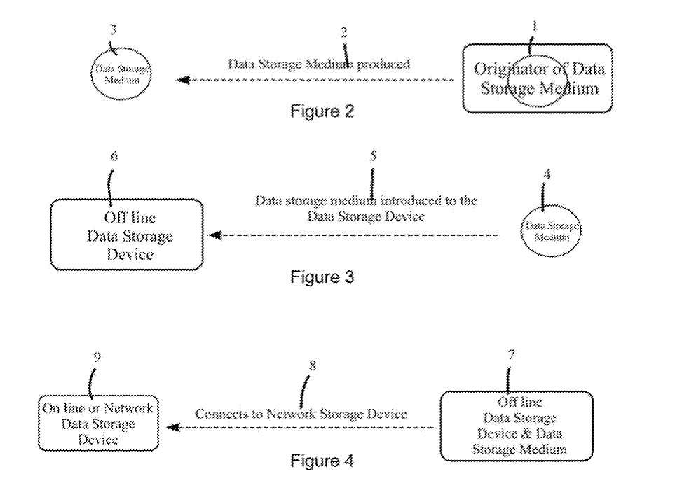

Referring now to FIGS. 2 through 8, flow charts that conceptually illustrate steps of an exemplary methodology according to the invention are shown. FIG. 2 conceptually illustrates a process 2 of using an originator 1, such as an originating computer system, to produce a data storage medium 3 marked with identification data.

FIG. 3 conceptually illustrates a relationship of a data storage medium 4 marked with identification data to an off-line data storage device 6, such as a hard drive of an end-user's computer. According to this step 5, the data storage medium is introduced into the off-line data storage device 6.

FIG. 4 conceptually illustrates the relationship of an off-line data storage device with a data storage medium having identification data to an on-line or network data storage device, such as a tracking computing device 150. The off-line data storage device 7 connects to and communicates with the on-line or network data storage device 9. The connection may be established via the Internet, an intranet or any other network(s) or combination thereof communicatively coupling the off-line data storage device 7 to the on-line or network data storage device 9.

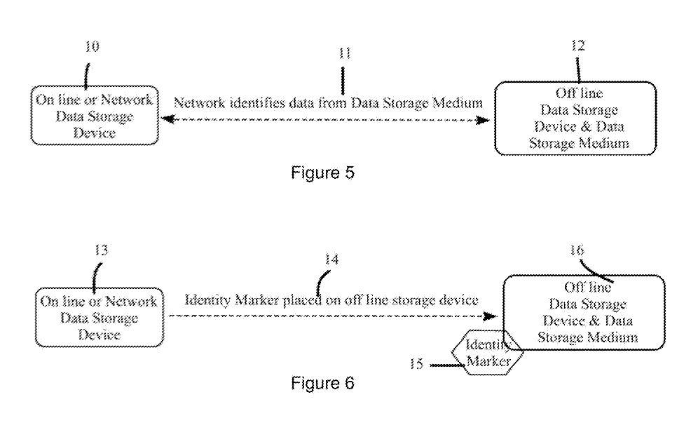

FIG. 5 conceptually illustrates identification 11 of an off-line data storage device 12 and data storage medium by an on-line or network data storage device 10. After receiving a connection and data and key pair, the on-line or network data storage device queries a database verifies that the off-line data storage device and data storage medium correspond to an off-line data storage device containing a data medium with a data and key pair. The off-line data storage device and data storage medium may transmit the data and key pair to the on-line data storage device using either manual or automatic means. Manual transmission may be achieved by means of a hyperlink or by the use of programming to automate the process. These actions can be singular or multiple in nature.

FIG. 6 conceptually illustrates an online or network data storage device 13 placing 14 an identity marker for (e.g., identification data) 15 on an off-line data storage device 16, where the data may reside for future identification. This action may be singular or multiple. Such placement may occur while maintaining a network connection. The identity marker, in the form of a text file, an executable, or any other form capable of being stored and accessed may be placed into various caches, temporary files or other storage spaces of the data storage device for future reference. The identity marker may specify data as it relates to the provider of the data storage medium. Once the identity marker is in place, the end-user may be properly associated with a provider of the data storage medium, whether or not the data storage medium is present or introduced.

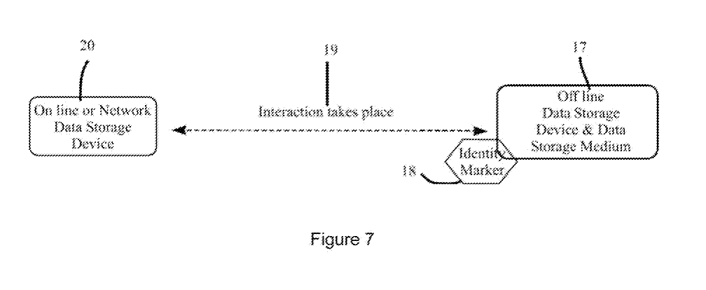

FIG. 7 conceptually illustrates an online or network data storage device 20 interacting 19 with an off-line data storage device 17, having an identity marker (e.g., identification data) 18. This action may be singular or multiple. As the identity marker is in place, the end-user may be properly associated with a provider of the data storage medium, whether or not the data storage medium is present or introduced.

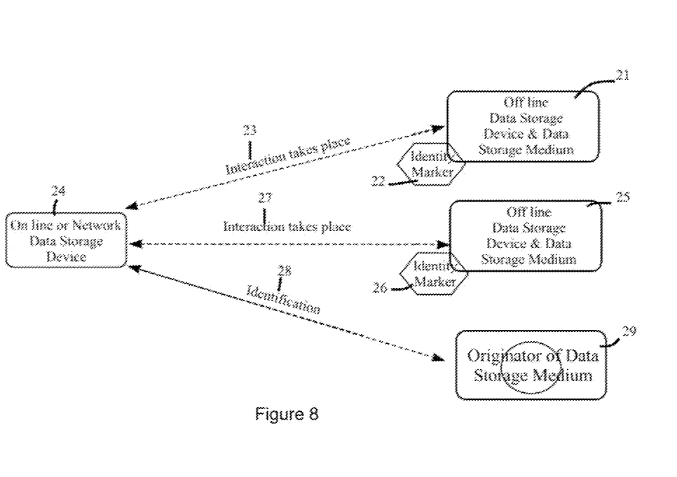

FIG. 8 conceptually illustrates a plurality of offline data storage devices 21 & 25 that already have identity markers 22 and 26, interacting 23 and 27 with an online or network data storage device 24. An originator of a data storage medium 29 interacting with the online or network data storage device 24, is also shown. The originator may provide originator data, identification data and first recipient data to the online or network data storage device 24. The offline data storage devices 21, 25 may provide identity marker data to the online or network data storage device 24. Thus components of this exemplary embodiment work in identifying the user of the storage medium, as well as the first recipient of the storage medium and its originator, and in identifying end-users that visit the online or network data storage device from an off-line or out of network location.

Optionally, a data storage medium marked with identification data according to principles of the invention may be configured to mark an off-line data storage device, such as end-user data storage device 130, with identification data. The identification data placed on the off-line data storage device by the data storage medium may thus be used to identify the off-line data storage device to a tracking computer in sessions, irrespective of whether the data storage medium is used. This approach for placement of identification data on the off-line data storage device by the data storage medium may be used in addition to or in lieu of the approach described above, entailing communication of an identity marker 155 to the end-user data storage device 130 by a tracking computing device 150.

Illustratively, specific retail store performance and consumer online usage associated with specific retailers can be tracked based on identity markers and identification data. This provides an originator with information to determine retail opportunities to get users online. Discount coupons, rebates, other rewards and the like, which have become an integral part of marketing strategies for many products, may be offered to entice end-users to participate. Retailers may be rewarded by originating manufacturers based upon user participation. Those skilled in the art will appreciate that countless other applications of the invention may be implemented without departing from the scope of the invention.

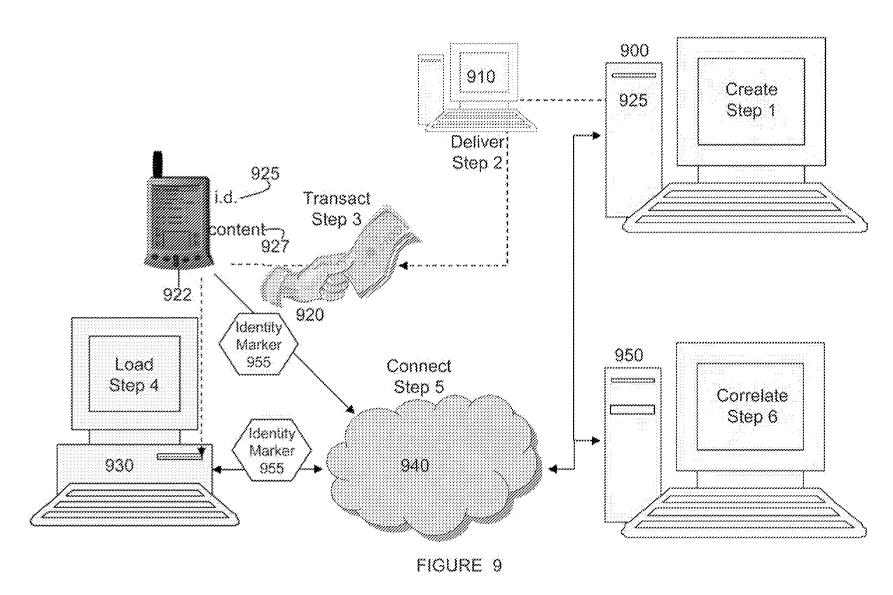

Referring now to FIG. 9, a high level block diagram and flow chart illustrates components of a system and steps of a methodology according to an alternative exemplary implementation of the invention. An originating computing device 900 contains software for generating computer code and identification data 925. The originating computing device 900 also includes software and a device for communicating the code and identification data 925 to a first recipient's computing device 910. The device for providing the identification data 925 may include network communication equipment and/or equipment for writing to and reading from removable media, such as, for example, a CD-R/RW and/or DVD-R/RW drive. Of course, the originating computing device 900 may include additional elements. Additionally, the originating computing device 900 may either stand alone or operate in a distributed environment. The originating computing device 900 is intended to represent a broad range of data storage and computing devices capable of performing functions according to Step 1, as discussed below.

In Step 1 of an exemplary alternative process according to the invention, the originating computing device 900 generates computer code, including identification data 925. By way of example and not limitation, the identification data 925 may include a data and key pair comprised of a unique identifying code and additional code to represent products or services to be promoted. Both sets of code in combination form a unique identifier. The code combination may be used to positively identify a first recipient and an origin of the associated data storage medium. The identification data 925 may be stored in a database or table on the originating computing device 900. Subsequently, the identification data 925 may be associated with one or more lower-tier participants in the supply chain, such as recipients and users.

Other content 927 such as information, audio, graphics, video, multimedia, games, scripts, programs and other computer software may be provided by the originating computing device 900. Additionally, the content 927 may include software to facilitate network communication with a tracking computing device 950, including transmission of the identification data 925.

Next, as in Step 2, the identification data 925 is delivered to a first recipient 910 via an off-line or on-line delivery method. By way of illustration and not limitation, the first recipient 910 may be a retailer, kiosk, sales agent, sales representative or some other person, entity, device or location in a supply chain. An objective of this step is to position the identification data 925 for eventual delivery to an end-user, such as a consumer. Thus, for example, the identification data 925 may be provided to retailers for delivery to consumers. The identification data 925 may accompany products for sale to consumers, include content for sale to end-users, or be distributed to end users in any other manner. At the time the originator provides the identification data 925 to the first recipient 910, an identification of the first recipient 910 may be stored and associated with the identification data 925 in a database or table on the originating computing device 900.

Advantageously, this embodiment of the invention provides brick and mortar establishment opportunity to efficiently benefit from subsequent on-line activity by its patrons. To achieve the foregoing, the patron must be physically present at the brick and mortar establishment (i.e., the location for receiving the identification data). Thus, this embodiment contemplates physical presence at the point of delivery for an end-user to receive the identification data.

Those skilled in the art will appreciate that the participants (e.g., the originator and recipient) may represent individual people, entities, or businesses. Additionally, other participants may be involved in phases of a methodology according to principles of the invention, such as processing companies, clearinghouses, loyalty companies, incentive companies, service providers and/or the like.

Next, as in Step 3, an end-user receives a copy of the identification data 925. The identification data 925 may be sold, freely given, or otherwise provided to an end-user, alone or accompanying another product or service pursuant to a transaction. The identification may be communicated to a portable storage device 922 in the possession of or provided to an end-user. By way of example and not limitation, the portable storage device 922 may be a personal digital assistant or other portable device equipped to receive and store data provided from an external source.

Upon completing Step 3, the end-user possesses a storage device 922, which has been marked with the identification data 925, and is configured to facilitate communication of the identification data 925 to a tracking computing device 950. Because the identification data 925 is associated with one or more lower-tier participants in the supply chain, such as a retail recipient, use of the storage device can be attributed to such participant(s).

In Step 4, an end-user who possesses a storage device 922, which has been marked with the identification data 925 communicates the identification data 925 to a compatible data storage device with network (e.g., Internet) connectivity, such as an end-user data storage device 930. In an exemplary embodiment, code accompanies the identification data 925 to facilitate communication with a tracking computing device 950. When an end-user loads the identification data 925 on an end-user data storage device 930, as in Step 4, the identification data 925 may initiate an online network communication session between the end-user data storage device 930 and a tracking computing device 950, as in Step 5. The loaded storage medium may initiate the online session by establishing an Internet connection, launching a browser and invoking a website or other Internet service configured to receive the identification data 925 and communicate the data to a tracking computing device 950. As another option, a program accompanying the identification data 925 may initiate modem-to-modem communications between the end-user data storage device 930 and the tracking computing device 950, or may connect to the Internet and to a web server configured to receive the identification data 925 and communicate the data to a tracking computing device 950. The tracking computing device 950 may be a web server with a software agent/component configured to read the identification data 925, along with other potential information (e.g., end-user identification, etc.). Any other techniques for establishing a network connection directly or indirectly between the end-user data storage device 930 and the tracking computing device 950 and providing the identification data 925 may be utilized without departing from the scope of the invention.

In use, the identification data 925 may be tracked from an originator 900 to a first recipient 910 and to an end-user 930. This tracking is enabled by providing the identification data 925 and physically delivering a device containing the identification data 925 to an end-user 930 and then to a tracking computing device 950. Use of the identification data 925 by an end user 930 may be correlated with the first recipient's 910 identity which is associated with the identification data 925. Thus, the first recipient 910 (e.g., a retailer) may be duly credited for the end-user's utilization and any ensuing transaction. As will become apparent hereinafter, various features may be afforded by associating an off-network recipient with a storage medium utilized by an end-user.

In a further embodiment, the storage medium may include exterior detectible indicia, such as a visible barcode or alphanumeric rendition of the identification data 925. The identity of each intermediate recipient (e.g., a retailer who receives the storage medium from a distributor, who received the storage medium from the originator) along with the identification data may be communicated to a tracking computing device 950. This enables maintenance of a chain of possession of the identification data 925. Thus, a database created by the originating computer 900 may associate each recipient (i.e., a first recipient 910 and each intermediate recipient) with the identification data 925. The identification data 925 may be provided by each intermediate recipient or sender using conventional on-line communication methods. Illustratively, access to a website or software may be provided to each recipient of a supply chain to provide the data to the originating computing device 900 and/or the tracking computing device 950. The data may be manually entered or automatically entered from an inventory management program.

The tracking computing device 950 is configured to perform several functions, such as maintaining communication sessions with one or more end-user data storage devices, and possibly one or more intermediate recipients. The tracking computing device 950 may also maintain or have access to a database (or table) of identification data, intermediate recipient data, and other information available concerning the identification data 925. The tracking computing device 950 and the originating computer 900 may be separate, communicatively coupled, or one and the same. Of course, the computer 950 may include additional elements. Additionally, the computer system 950 may either stand alone or operate in a distributed environment. The tracking computing device 950 is intended to represent a broad range of computing devices capable of performing functions according to the invention.

In an exemplary implementation, the tracking computing device 950 is also configured to communicate an identity marker 955 for storage on the end-user data storage device 930. The identity marker 955 may be used to identify the end-user in future sessions between the tracking computing device and the end-user data storage device 930, without further need for the identification data 925. The identity marker 955 may be correlated with the originator 900 and the identity of the first recipient 910 in such future sessions.

Thus an exemplary method according to the invention enables identification and authentication of user(s) of the system as it relates to an origin and stemming from a specific off-line or out of network source (i.e., a recipient). This enables an online database to record these electronic transactions and refer to them for other transactions. Long-term and short-term tracking may be accomplished by the placement of digital markers on a user's machine that identifies the user now and in the future for crediting the off-line source (i.e., recipient) for the visit. The credit may include possible financial compensation or some other perquisite. The identification data 925 introduced to the off-line, out of network, data storage device enables the foregoing, as discussed above. This identification data 925 binds (i.e., associates) the transactions and parties. The associated data provides a basis for countless transactions unlimited in scope and kind.

Those skilled in the art will appreciate that the originating computing device may be a system comprised of a computing device, a distributed system including one or more computing devices, a plurality of networked computing devices or a combination of any or all of the foregoing. Likewise, the tracking computing device may be a system comprised of a computing device, a distributed system including one or more computing devices, a plurality of networked computing devices or a combination of any or all of the foregoing. Such implementations of originating and tracking computing devices and systems are intended to come within the scope of an embodiment of the invention.

Those skilled in the art will also appreciate that the principles of the invention may readily be adapted in alternative embodiments to identify participants in a supply chain that includes physical (off-network) delivery. In one such embodiment, in lieu of using a storage medium, a consumer may attend a retail outlet with a portable storage medium and through mechanical and or electronic interaction have the unique identifying data placed onto their portable data storage device. Subsequently, at the same or another location, this data could then be introduced to a device with Internet or network connectivity. When that device is connected to the internet or network, the identifying data, which corresponds to the off line or out of network participant, is communicated to a tracking computer and products or services procured by the end-user are associated with the data.

In another embodiment, a consumer may attend a retail location and have a part of their anatomy read by an in store or on location data storage device through mechanical or electronic interaction to identify the user or consumer. The consumer later attending a data storage device capable of reading or understanding the same information transmits this data passively or actively to an on line or network data storage device that can identify and correlate the data to that of an individual having been at the off line or out of network location in the past.

As an alternative to placing an identity marker onto a consumer's data storage device, a method and system according to principles of the invention may use unique characteristics of the end user data storage device (e.g., a MAC address) to maintain a record of the end user and their associated data storage device. Illustratively, an identification code from a microprocessor, registration information, etc., could be read passively or actively, meaning with or without the users permission by an on line data storage device using computer language to ascertain or mine the information from the device.

As another alternative to placing an identity marker onto a consumer's data storage device, software may be permanently introduced to an end user's data storage device, either through a data storage medium or an on-line data storage medium. The introduced software may identify an end user either by mining personal information or by assigning a unique identifier to the end user and/or the data storage device.

Upon transmission or delivery of the identification data, the data may be redirected or bounced in order to perform or support other metrics and functions to enable tracking or redirection either singular or multiple. Unique and or identifying data is transmitted using the Internet or Network acting as a conduit to identify and facilitate a brick and mortar responsible selling party to a product or service provider where in turn the product or service provider compensates the brick and mortar responsible selling party.

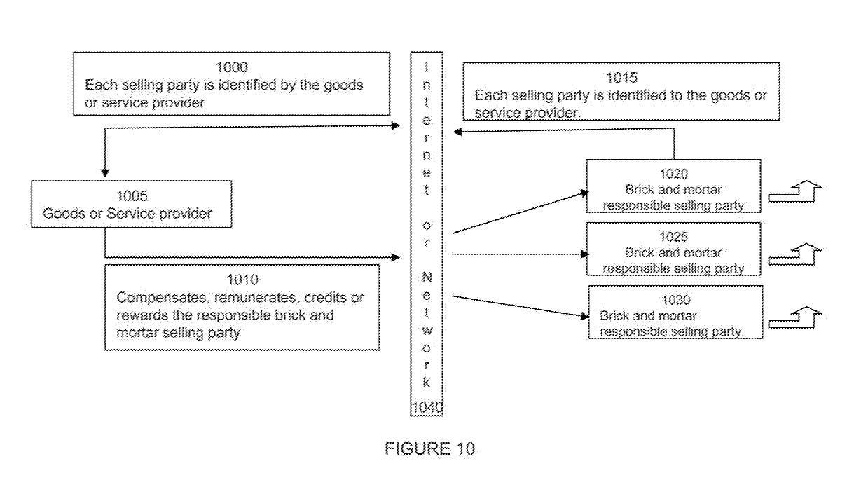

Now referring to FIG. 10, a high level data flow diagram for an exemplary system and method according to principles of the invention is shown. The brick and mortar responsible selling parties 1020-1030 are examples of first recipients, as discussed above. The selling parties 1020-1030 also receive media containing identification data, or the identification data, which they provide to end-users. Because the identification is provided to end-users on portable media or to an end user's portable storage device, end users may physically transport the identification data. The identification data may subsequently and/or in parallel be communicated to a tracking computing device via a network. When an end user utilizes identification data (or other code accompanying or incorporating the identification data), the corresponding selling party 1020-1030 is identified 1000 & 1015 to the originating party (i.e., the goods or services party) 1005. The originating party (i.e., the goods or services party) 1005 may then compensate, remunerate, credit or otherwise reward the corresponding selling party 1020-1030 for the end-user activity.

While the invention has been described in terms of various embodiments and implementations, those skilled in the art will recognize that the invention can be practiced with modification within the spirit and scope of the appended claims.

What is claimed is:

1. A method for tracking data, said method comprising steps of associating identification data with a first recipient, providing the identification data to the first recipient for provision to an end-user physically present at a point of delivery on a portable storage device, receiving the identification data via network communication upon use of the portable storage device by the end-user.

2. A method for tracking data according to claim 1, further comprising a step of associating said use of the portable storage device by said end-user with said first recipient.

3. A method for tracking data according to claim 1, further comprising a step of determining the first recipient.

4. A method for tracking data according to claim 1, wherein said portable storage device is a device from a group consisting of a portable storage medium, a portable non-volatile memory, and a portable computing device.

5. A method for tracking data according to claim 4, said method further comprising a step of physically delivering the portable storage device, with said identification data stored thereon, to said first recipient.

6. A method for tracking data according to claim 1, wherein said portable storage device is a portable computing device physically present at the point of delivery when identification data is stored thereon, and said method further comprises a step of establishing communication connectivity between a first recipient computing device and said portable storage device.

7. A method for tracking data according to claim 1, wherein the step of associating the identification data with a first recipient further comprises a step of creating a database record that includes an identification of the first recipient.

8. A method for tracking data according to claim 1, said method further comprising a step of establishing communication connectivity between an end user computing device and a tracking computing device.

9. A method for tracking data according to claim 8, wherein said end user computing device is a portable computing device that was physically present at the point of delivery when identification data was stored thereon.

10. A method for tracking data according to claim 6, said method further comprising a step of transmitting the identification data from the end user computing device to the tracking computing device.

11. A method for tracking data according to claim 6, said method further comprising a step of transmitting an identity marker from the tracking computing device to the end user computing device.

12. A method for tracking data according to claim 6, said method further comprising steps of transmitting the identification data from the end user computing device to the tracking computing device, and transmitting an identity marker from the tracking computing device to the end user computing device.

13. A method for tracking data according to claim 1, said method further comprising a step of compensating said first recipient for use of the portable storage device by said end-user associated with said first recipient.

14. A method for tracking data according to claim 1, said method further comprising a step of compensating said first recipient for use of the portable storage device by said end-user associated with said first recipient, wherein said step of compensating includes a step from the group consisting of providing monetary compensation to said first recipient, providing non-monetary compensation to said first recipient, providing a credit to said first recipient, providing a discount to said first recipient, providing a rebate to said first recipient, and providing a priority to said first recipient.

15. A system for tracking data, said system comprising an originating computing system configured to associate identification data with a first recipient, and communicate identification data to a portable storage device physically present at a point of delivery for storage thereon, a tracking computing system configured to receive the identification data via network communication upon use of the portable storage device by an end-user computing device, and associate said use of the portable storage device by said end-user computing device with said first recipient.

16. A system for tracking data according to claim 14, wherein the originating computer system and the tracking computer system are part of an integrated computer system.

17. A system for tracking data according to claim 14, wherein the originating computer system and the tracking computer system are part of a distributed computer system.

18. A system for tracking data according to claim 14, wherein the originating computer system is further configured to determine the first recipient.

19. A system for tracking data according to claim 14, wherein said portable storage device is a device from the group consisting of a portable storage medium, a non-volatile memory, and a portable computing device, and said system further includes means for providing the portable storage device, with said identification data stored thereon, to said first recipient.

20. A system for tracking data according to claim 14, wherein said portable storage device is a portable computing device without an established Internet connection at a time when identification data is stored thereon, and said system further includes means for establishing communication connectivity between an originating computing system and said portable storage device.

21. A system for tracking data according to claim 14, wherein the originating computing system is further configured to create a database record that includes the identification data and an identification of the first recipient.

22. A system for tracking data according to claim 14, further comprising a tracking computing device configured to receive the identification data from the end user computing device.

23. A system for tracking data according to claim 15, wherein the tracking computing system is configured to transmit an identity marker to the end user computing device.

24. A system for tracking data according to claim 14, further comprising a tracking computing system configured to receive the identification data from the end user computing device, and transmit an identity marker to the end user computing device.
